(19) United States
(12) Patent Application Publication
(10) Pub. No.: US 2018/0210311 A1
(43) Pub. Date: Jul. 26, 2018

(54) ELECTROPHORESIS DEVICE AND ELECTRONIC APPARATUS

(71) Applicant: SEIKO EPSON CORPORATION, Tokyo (JP)

(72) Inventor: Hiroshi SERA, Chino-shi (JP)

(73) Assignee: SEIKO EPSON CORPORATION, Tokyo (JP)

(21) Appl. No.: 15/865,687

(22) Filed: Jan. 9, 2018

(30) Foreign Application Priority Data
Jan. 26, 2017 (JP) 2017-012000

(51) Int. Cl. G02F 1/167; C09D 5/44; C08F 257/02; C09B 67/08

(52) U.S. Cl. CPC G02F 1/167; C09B 67/0013; C08F 257/02; C09D 5/44

(57) ABSTRACT

An electrophoresis device includes a first substrate and a second substrate that retain an electrophoretic dispersion liquid including charged particles and a dispersion medium, and a partition wall portion that partitions a gap between the first substrate and the second substrate into a plurality of cells, in which the partition wall portion includes a communicating portion that causes the adjacent cells to communicate with each other.

### BACKGROUND

### 1. Technical Field

The present invention relates to a technology for displaying an image by using a dispersion liquid (referred to as “electrophoretic dispersion liquid”, hereinafter) in which charged particles are dispersed in a dispersion medium.

### 2. Related Art

JP-A-2009-229911 discloses an electrophoresis device which retains an electrophoretic dispersion liquid in a gap between an element substrate and a counter substrate facing each other. The gap between the element substrate and the counter substrate is partitioned into a plurality of cells by a partition wall portion which is formed between both substrates. The electrophoretic dispersion liquid is accommodated in each cell.

In the technology of JP-A-2009-229911, each cell is a sealed space. Accordingly, for example, if the dispersion medium of the electrophoretic dispersion liquid expands or contracts due to a temperature change or the like, there is a possibility that stress occurs in the partition wall portion, and the partition wall portion is deformed.

### SUMMARY

An advantage of some aspects of the invention is to prevent deformation of a partition wall portion in an electrophoresis device.

An electrophoresis device according to a preferred aspect of the invention includes a first substrate and a second substrate that retain an electrophoretic dispersion liquid including charged particles and a dispersion medium, and a partition wall portion that partitions a gap between the first substrate and the second substrate into a plurality of cells, in which the partition wall portion includes a communicating portion that causes the adjacent cells to communicate with each other. In the aspect, since the partition wall portion includes the communicating portion that causes the adjacent cells to communicate with each other, the dispersion medium of the electrophoretic dispersion liquid may flow between the cells through the communicating portion. Therefore, even in a case where the dispersion medium expands or contracts, for example, due to a temperature change, there is an advantage of capable of preventing deformation of the partition wall portion.

In a preferred aspect of the invention, the communicating portion may have a size through which the charged particles are not capable of passing. In the aspect, since the communicating portion of the size through which the charged particles are not capable of passing is formed, the dispersion medium flows between the cells, meanwhile, the charged particles do not move between the cells. Therefore, since it is prevented that display quality is lowered, for example, due to uneven distribution of the charged particles, there is an advantage of capable of preventing the deformation of the partition wall portion.

In a preferred aspect of the invention, the partition wall portion may include a first portion that extends in a first direction, and a second portion that extends in a second direction intersecting with the first direction, and the first portion and the second portion may be disposed to be separated from each other through the communicating portion. In the aspect, it is possible to cause the dispersion medium to flow between the cells through the communicating portion between the first portion and the second portion. In a configuration in which the first portion and the second portion intersect with each other, there is a possibility that a height of the portion intersecting with each other in the partition wall portion becomes high in comparison with other portions. According to the configuration in which the first portion and the second portion are disposed to be separated from each other through the communicating portion, a difference (variation) of the height of the partition wall portion is reduced, in comparison with the configuration in which the first portion and the second portion intersect each other. Therefore, it is possible to cause the first substrate or the second substrate to adhere to the partition wall portion with high accuracy.

In a preferred aspect of the invention, the partition wall portion may include a third portion that extends in the first direction, and the first portion and the second portion maybe disposed to be separated from the third portion through the communicating portion. In the aspect, it is possible to cause the dispersion medium to flow between the cells through the communicating portion between the first portion, the second portion, and the third portion. In a configuration in which the first portion, the second portion, and the third portion are continuous with each other, the above-described tendency that the height of the partition wall portion becomes high in comparison with other portions, at the portion where the first portion, the second portion, and the third portion intersect each other, may become obvious. According to the above-described aspect in which the first portion, the second portion, and the third portion are disposed to be separated from each other through the communicating portion, it is possible to effectively reduce the difference of the height of the partition wall portion.

In a preferred aspect of the invention, the partition wall portion may include a fourth portion that extends in the second direction, and the first portion, the second portion, and the third portion may be disposed to be separated from the fourth portion through the communicating portion. In the aspect, it is possible to cause the dispersion medium to flow between the cells through the communicating portion between the first portion, the second portion, the third portion, and the fourth portion. In a configuration in which the first portion, the second portion, the third portion, and the fourth portion are continuous with each other, the above-described tendency that the height of the partition wall portion becomes high in comparison with other portions, at the portion where the first portion, the second portion, the third portion, and the fourth portion intersect each other, may become obvious. According to the above-described aspect in which the first portion, the second portion, the third portion, and the fourth portion are disposed to be separated from each other through the communicating portion, it is possible to effectively reduce the difference of the height of the partition wall portion.

In a preferred aspect of the invention, the partition wall portion may include a first portion that extends in a first direction, a second portion that extends in a second direction intersecting with the first direction, and a third portion that extends in the first direction, the first portion and the third portion may be positioned on opposite sides to each other by interposing the second portion between the first portion and the third portion, and each of the first portion and the third portion may be disposed to be separated from the second portion through the communicating portion. In the aspect, it is possible to cause the dispersion medium to flow between the cells through the communicating portion between each of the first portion and the third portion, and the second portion. Since each of the first portion and the third portion, and the second portion are disposed to be separated from each other through the communicating portion, it is possible to effectively reduce the difference of the height of the partition wall portion.

An electronic apparatus according to a preferred aspect of the invention includes the electrophoresis device according to the aspect described above. For example, a timepiece or an electronic paper is a preferable example of the electronic apparatus, but the scope of application of the invention is not limited thereto.

A method for manufacturing an electrophoresis device according to a preferred aspect of the invention is a method for manufacturing an electrophoresis device which includes a first substrate and a second substrate that retain an electrophoretic dispersion liquid including charged particles and a dispersion medium, and a partition wall portion that partitions a gap between the first substrate and the second substrate into a plurality of cells, the method including exposing a photosensitive layer that is formed of a positive type photosensitive material on a surface of the first substrate or the second substrate, by using a photomask where a transmissive area through which irradiation light is transmitted is formed, and forming the partition wall portion by developing the photosensitive layer after the exposing, in which the transmissive area of the photomask includes a first area that extends in a first direction, and a second area that extends in a second direction intersecting with the first direction, and the first area and the second area are separated from each other. In a case where the photomask in which the first area and the second area of the transmissive area are continuous with each other is used for the exposing of the photosensitive layer, since an exposure value to a portion corresponding to the intersecting of the first area with the second area in the photosensitive layer becomes larger than the exposure values to other portions, there is a possibility that the height of the portion corresponding to the intersecting in the partition wall portion becomes high in comparison with other portions. According to the above-described aspect in which the photomask in which the first area and the second area are separated from each other is used for the exposing of the photosensitive layer, the exposure value to the portion corresponding to the intersecting of the first area with the second area in the photosensitive layer, is reduced. Therefore, it is possible to prevent the difference (variation) of the height of the partition wall portion, and it is possible to cause the first substrate or the second substrate to adhere to the partition wall portion with high accuracy.

### BRIEF DESCRIPTION OF THE DRAWINGS

The invention will be described with reference to the accompanying drawings, wherein like numbers reference like elements.

FIG. 1 is a plan view of an electrophoresis device according to a first embodiment of the invention.

FIG. 2 is a sectional view of the electrophoresis device.

FIG. 3 is a configuration diagram of a unit circuit.

FIG. 4 is a sectional view obtained by enlarging the electrophoresis device.

FIG. 5 is a plan view of a partition wall portion.

FIG. 6 is a plan view obtained by enlarging an area α in FIG. 5.

FIG. 7 is a diagram for illustrating a process P1 in a method for manufacturing an electrophoresis device.

FIG. 8 is a diagram for illustrating a process P2 in the method for manufacturing the electrophoresis device.

FIG. 9 is a diagram for illustrating a process P3 (exposure) in the method for manufacturing the electrophoresis device.

FIG. 10 is a plan view of a photomask which is used in the process P3.

FIG. 11 is a diagram for illustrating a process P4 (development) in the method for manufacturing the electrophoresis device.

FIG. 12 is a plan view and a sectional view of a partition wall portion in Comparative Example.

FIG. 13 is a plan view of a photomask in Comparative Example.

FIG. 14 is a plan view of a partition wall portion according to a second embodiment.

FIG. 15 is a plan view obtained by enlarging an area α in FIG. 14.

FIG. 16 is a plan view of a partition wall portion according to a third embodiment.

FIG. 17 is a plan view obtained by enlarging an area α in FIG. 16.

FIG. 18 is a front view of a wristwatch which is an example of an electronic apparatus.

FIG. 19 is a perspective view of an electronic paper which is an example of the electronic apparatus.

### DESCRIPTION OF EXEMPLARY EMBODIMENTS

### First Embodiment

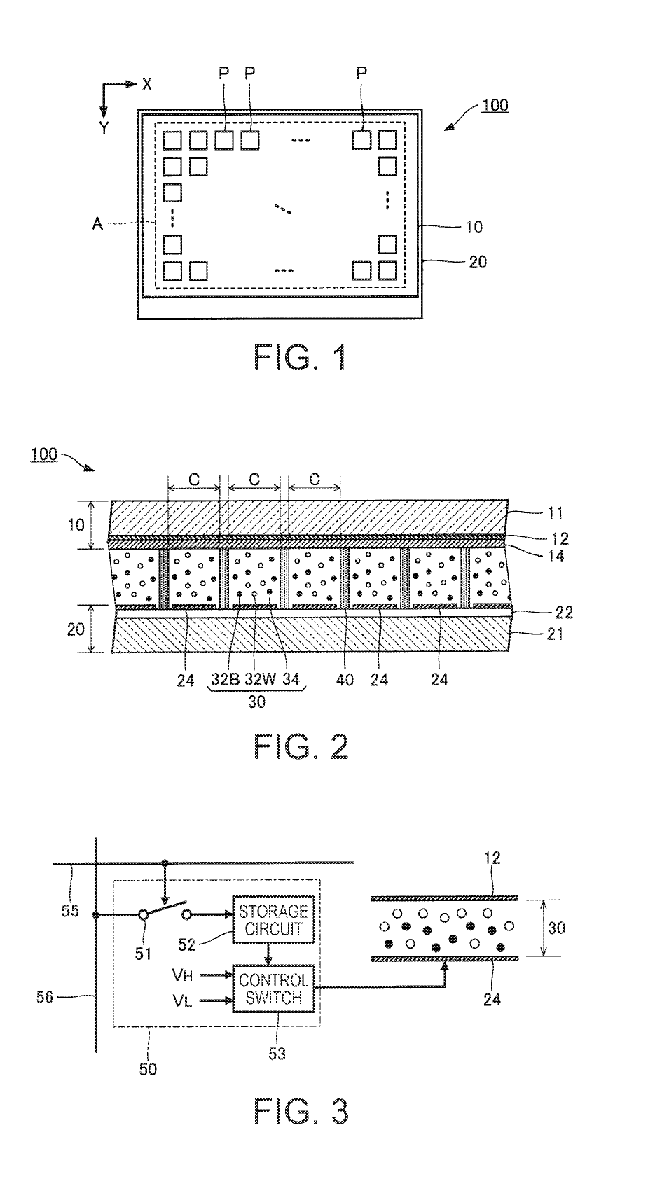

FIG. 1 is a plan view of an electrophoresis device 100 according to a first embodiment of the invention. The electrophoresis device 100 of the first embodiment is a display device that displays an image by using a plurality of pixels P. The plurality of pixels P are arrayed into a matrix within a pixel area A throughout an X-direction (an example of a first direction) and a Y-direction (an example of a second direction) intersecting with each other. As illustrated in FIG. 1, the electrophoresis device 100 includes a first substrate 10 and a second substrate 20 which are bonded to each other at an interval. The first substrate 10 is positioned on a side of a user who visually recognizes a display image, and the second substrate 20 is positioned on an opposite side (rear surface side) to the user.

FIG. 2 is a sectional view of the electrophoresis device 100. As illustrated in FIG. 2, an electrophoretic dispersion liquid 30 is retained in a gap between the first substrate 10 and the second substrate 20. The electrophoretic dispersion liquid 30 is a display medium that displays a gradation by using electrophoresis of a plurality of charged particles 32 (32B, 32W). Specifically, the electrophoretic dispersion liquid 30 is configured to include the white charged particles 32W and the black charged particles 32B that are charged at reversed polarities to each other, and a dispersion medium 34 in which the plurality of charged particles 32 (32W, 32B) are migratably dispersed.

As illustrated in FIG. 2, the first substrate 10 is configured to include a base material 11, a common electrode 12, and an insulating layer 14. The base material 11 is a plate-shaped member of light-transmissive properties. The common electrode 12 and the insulating layer 14 are formed on a surface facing the second substrate 20 in the base material 11. The common electrode 12 is a continuous electrode throughout the plurality of pixels P within the pixel area A, and is formed of a conductive material having the light-transmissive properties such as indium tin oxide (ITO) or indium zinc oxide (IZO), for example. The insulating layer 14 is a film of the light-transmissive properties which covers the common electrode 12. A material of the insulating layer 14 is arbitrary, but for example, an inorganic material such as silicon oxide or silicon nitride, or various kinds of resin materials is suitable.

As illustrated in FIG. 2, the second substrate 20 is configured to include a base material 21, a circuit layer 22, and a plurality of pixel electrodes 24. The base material 21 is a plate-shaped member. The circuit layer 22 is formed on the surface facing the first substrate 10 in the base material 21. The circuit layer 22 is configured by stacking a plurality of layers including a conductive layer and the insulating layer, and includes a plurality of circuit elements (for example, transistors) and a plurality of wirings. The plurality of pixel electrodes 24 are formed on the surface of the circuit layer 22. For example, the plurality of pixel electrodes 24 are formed of the conductive material having the light-transmissive properties such as ITO or IZO. Each pixel electrode 24 is a substantially rectangular-shaped electrode which is individually formed per pixel P. On an inside of the pixel area A, the plurality of pixel electrodes 24 are arrayed into a matrix at intervals to each other in the X-direction and the Y-direction.

The plurality of charged particles 32 migrate in accordance with a voltage between the pixel electrode 24 and the common electrode 12, thereby, the gradation (white/black) is prevented per pixel electrode 24. For example, the white charged particles 32W approach the common electrode 12, thereby, white is displayed, and the black charged particles 32B approach the common electrode 12, thereby, black is displayed. As understood from the above description, a portion where the pixel electrode 24 and the common electrode 12 face each other by interposing the electrophoretic dispersion liquid 30 therebetween, functions as a pixel P.

In the circuit layer 22 of the first embodiment, a unit circuit 50 illustrated in FIG. 3 is formed per pixel P. Each unit circuit 50 is configured to include a selection switch 51, a storage circuit 52, and a control switch 53. As described above, each component of the unit circuit 50 is configured with the circuit element (for example, the transistor) and the wiring in the circuit layer 22.

The selection switch 51 is a switch that controls an electrical connection (conduction/insulation) between a signal line 56 which extends in the Y-direction and the storage circuit 52 by being interposed therebetween. As illustrated in FIG. 3, a control terminal of the selection switch 51 is connected to a selection line 55 which extends in the X-direction. If the selection switch 51 is transited to an ON state in accordance with a signal which is supplied to the selection line 55, a gradation signal in accordance with the gradation which is designated to the pixel P is attracted to the unit circuit 50 from the signal line 56. The storage circuit 52 retains the gradation signal which is attracted from the signal line 56 through the selection switch 51. For example, a static random access memory (SRAM) which is configured with a latch circuit or a dynamic random access memory (DRAM) which is configured with a capacitive element is suitable as a storage circuit 52. The control switch 53 supplies one of an electric potential VH and an electric potential VL to the pixel electrode 24 in accordance with the gradation signal which is retained in the storage circuit 52. The electric potential VH is higher than the electric potential VL. For example, the electric potential VH is a power source electric potential of a high rank side, and the electric potential VL is a ground electric potential.

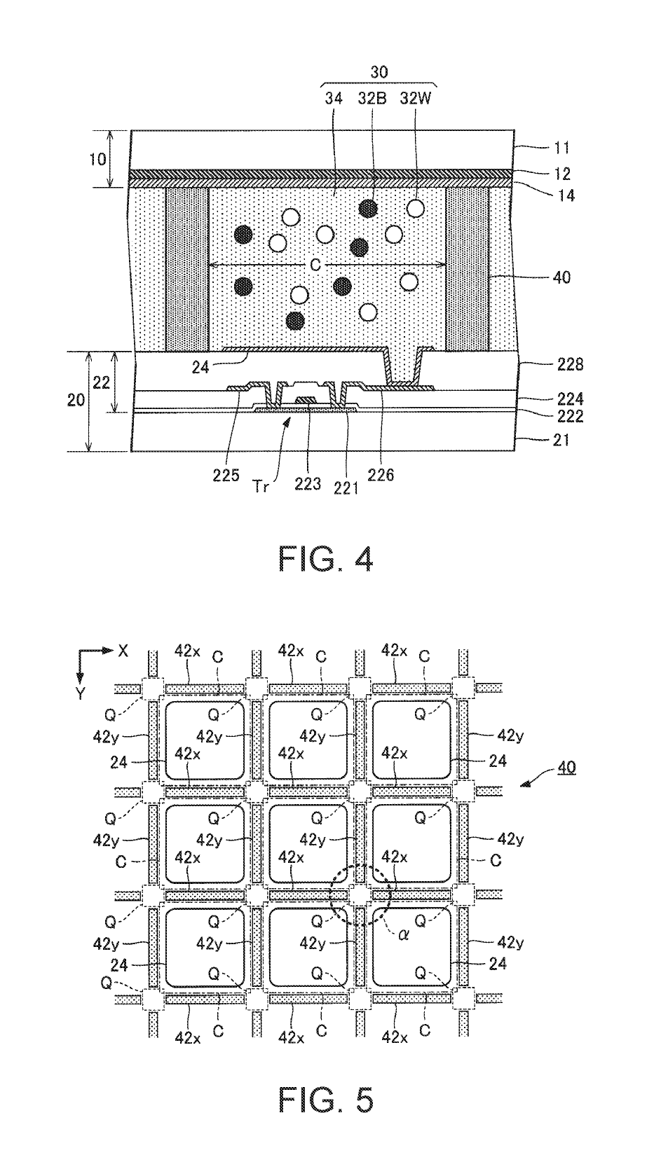

FIG. 4 is a sectional view obtained by enlarging the vicinity of one transistor Tr which is formed in the circuit layer 22. The transistor Tr is configured to include a semiconductor layer 221, a gate electrode 223, a source electrode 225, and a drain electrode 226. For example, the semiconductor layer 221 is formed of a semiconductor material such as polysilicon, on the surface of the base material 21. For example, the gate electrode 223 is formed of a conductive material such as molybdenum (Mo), and faces a channel area of the semiconductor layer 221 by interposing a gate insulating layer 222 therebetween. The insulating layer 224 of FIG. 4 covers the semiconductor layer 221 and the gate electrode 223. The source electrode 225 and the drain electrode 226 are formed on the surface of the insulating layer 224, and are conductive to the semiconductor layer 221 through a conduction hole (contact hole) which passes through the insulating layer 224 and the gate insulating layer 222.

An insulating layer 228 is formed on the surface of the insulating layer 224. For example, the insulating layer 228 is configured by stacking the plurality of layers which are formed of the inorganic material such as silicon oxide or silicon nitride, or various kinds of resin materials. The plurality of pixel electrodes 24 are formed on the surface of the insulating layer 228. The pixel electrode 24 is electrically connected to the transistor Tr (for example, the drain electrode 226) of the pixel circuit through the conduction hole which passes through the insulating layer 228.

As illustrated in FIG. 2 and FIG. 4, the partition wall portion 40 is formed between the first substrate 10 and the second substrate 20. The partition wall portion 40 of the first embodiment is formed on the surface (surface of the insulating layer 228, in more detail) of the second substrate 20, and a top surface of the partition wall portion 40 is in contact with on the surface (surface of the insulating layer 14, in more detail) of the first substrate 10. The partition wall portion 40 is a structure that is positioned on the inside of the pixel area A, and partitions the gap between the first substrate 10 and the second substrate 20 into a plurality of spaces (referred to as “cells”, hereinafter) C. For example, the partition wall portion 40 is formed to have a height of 20 μm or more (typically, 30 μm). In the first embodiment, the gap between the first substrate 10 and the second substrate 20 is partitioned by the partition wall portion 40 per pixel P, and the plurality of cells C are arrayed into a matrix in the X-direction and the Y-direction. As illustrated in FIG. 2 and FIG. 4, the electrophoretic dispersion liquid 30 is accommodated in each of the plurality of cells C which are partitioned by the partition wall portion 40. The material of the partition wall portion 40 is arbitrary, but a photosensitive resin material (photosensitive material) is suitable.

FIG. 5 is a plan view illustrating a planar shape of the partition wall portion 40. As illustrated in FIG. 5, the partition wall portion 40 of the first embodiment is configured to include a plurality of portions 42x and a plurality of portions 42y. Each of the plurality of portions 42x is a long-shaped portion which extends in the X-direction within an area that is interposed between two pixels P (pixel electrodes 24) which are adjacent to each other in the Y-direction. That is, the pixel P is positioned between two portions 42x which are adjacent to each other in the Y-direction. On the other hand, each of the plurality of portions 42y is a long-shaped portion which extends in the Y-direction within an area that is interposed between two pixels P (pixel electrodes 24) which are adjacent to each other in the X-direction. That is, the pixel P is positioned between two portions 42y which are adjacent to each other in the X-direction. As illustrated in FIG. 5, the plurality of portions 42x are arrayed at intervals to each other in the X-direction, and the plurality of portions 42y are arrayed at intervals to each other in the Y-direction.

A rectangular-shaped space of which four sides are surrounded by two portions 42x adjacent to each other in the Y-direction and two portions 42y adjacent to each other in the X-direction, is equivalent to one cell C. As understood from FIG. 5, the plurality of cells C which are adjacent to each other in a planar view, communicate with each other through a gap Q (referred to as “communicating portion”, hereinafter) between the portion 42x and the portion 42y. That is, the communicating portion Q is a flow path that causes the plurality of cells C to communicate with each other. As understood from FIG. 5, each communicating portion Q is a space that is formed at a point in which the array of the plurality of portions 42x along the X-direction and the array of the plurality of portions 42y along the Y-direction intersect with each other. Assuming a lattice obtained by combining a straight line that extends in the X-direction within the gap between each of the pixels P which are adjacent to each other in the Y-direction and a straight line that extends in the Y-direction within the gap between each of the pixels P which are adjacent to each other in the X-direction, the communicating portion Q is formed at each lattice point (intersecting point of each straight line) of the lattice.

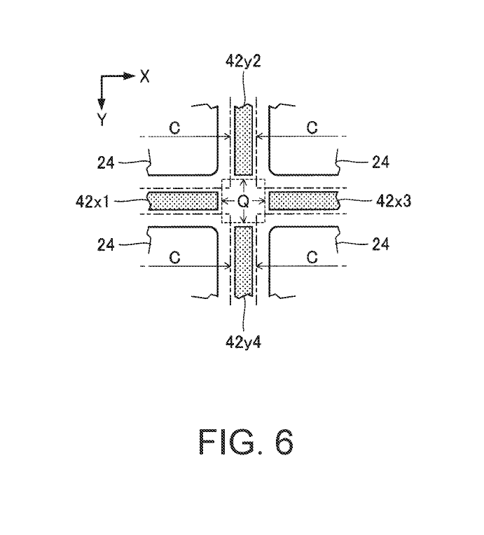

FIG. 6 is a plan view obtained by enlarging an area α in FIG. 5. As illustrated in FIG. 6, in the partition wall portion 40, the attention is given to two portions 42x (42x1, 42x3) which are adjacent to each other in the X-direction, and two portions 42y (42y2, 42y4) which are adjacent to each other in the Y-direction. As understood from FIG. 6, the portion 42x1 (an example of a first portion), the portion 42y2 (an example of a second portion), the portion 42x3 (an example of a third portion), and the portion 42y4 (an example of a fourth portion) are formed at positions which are separated from each other through the communicating portion Q.

As described in detail above, the communicating portion Q that causes the cells C which are adjacent to each other in a planar view to communicate with each other, is formed in the partition wall portion 40. Therefore, the dispersion medium 34 of the electrophoretic dispersion liquid 30 which is accommodated in each cell C, may flow between the cells C through the communicating portion Q. On the other hand, a size of each communicating portions Q is set such that the charged particles 32 are not capable of passing through the communicating portion Q. Specifically, the gap (that is, a flow path width of the communicating portion Q) between the portion 42x and the portion 42y which define arbitrary one cell C, is smaller than a particle diameter (for example, an average particle diameter) of the charged particle 32. For example, in a case where the particle diameter of the charged particle 32 is 300 nm to 400 nm, the gap between the portion 42x and the portion 42y is set to 300 nm or less. According to the above configuration, the charged particles 32 are retained in one cell C without moving between the cells C. That is, the charged particles 32 are not unevenly distributed in a specific cell C. In actual, there is a possibility that the plurality of charged particles 32 migrate in a state of being aggregated. Therefore, even in a case where the flow path width of the communicating portion Q is larger than the particle diameter of one charged particle 32, the charged particles 32 are not capable of passing through the communicating portion Q.

As described above, in the first embodiment, since the communicating portion Q that causes the adjacent cells C to communicate with each other is formed in the partition wall portion 40, for example, in a case where the dispersion medium 34 expands or contracts due to a temperature change, the dispersion medium 34 may flow between the cells C through the communicating portion Q. Therefore, stress of the partition wall portion 40 due to the expanding or the contracting of the dispersion medium 34 is reduced. As a result, it is possible to prevent deformation of the partition wall portion 40. In the first embodiment, since the communicating portion Q of the size through which the charged particles 32 are not capable of passing is formed in the partition wall portion 40, there is an advantage that it is possible to prevent the deformation of the partition wall portion 40 while preventing display quality from being lowered, for example, due to uneven distribution of the charged particles 32.

### Method for Manufacturing Electrophoresis Device 100

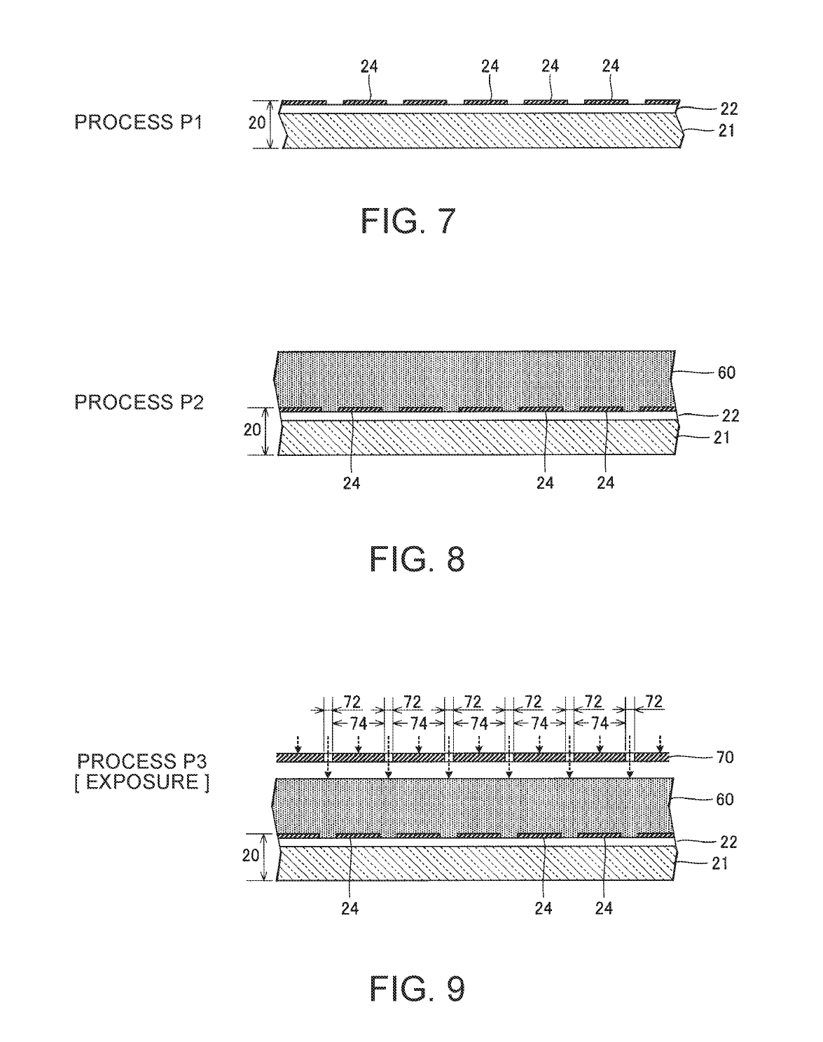

A method for manufacturing the electrophoresis device 100 described above will be described. As illustrated in FIG. 7, in a process P1, the second substrate 20 in which the circuit layer 22 and the plurality of pixel electrodes 24 are formed on the surface of the base material 21, is prepared. For the formation of the circuit layer 22 and each pixel electrode 24, for example, various manufacturing technologies such as a semiconductor manufacturing technique may arbitrarily be adopted.

In a process P2 after the process P1, as illustrated in FIG. 8, a photosensitive layer 60 is formed on the surface of the second substrate 20 in which the circuit layer 22 and the plurality of pixel electrodes 24 are formed on the surface of the base material 21. Specifically, a photosensitive material is coated on the surface of the second substrate 20 by a known coating technology, and the photosensitive material is baked (pre-baked) at 110° C. from 90° C., for example, for approximately 20 minutes, thereby, the photosensitive layer 60 is formed. For the formation of the photosensitive layer 60, a negative type photosensitive material in which an exposed portion remains after development is used. For example, a film thickness of the photosensitive layer 60 is 20 μm or more (typically, approximately 30 μm).

In a process P3 (an example of an exposure process) after the process P2, as illustrated in FIG. 9, the photosensitive layer 60 is exposed by using a photomask 70. A transmissive area 72 that transmits irradiation light from a light source, and a light-shielding area 74 that shields the irradiation light are formed in the photomask 70.

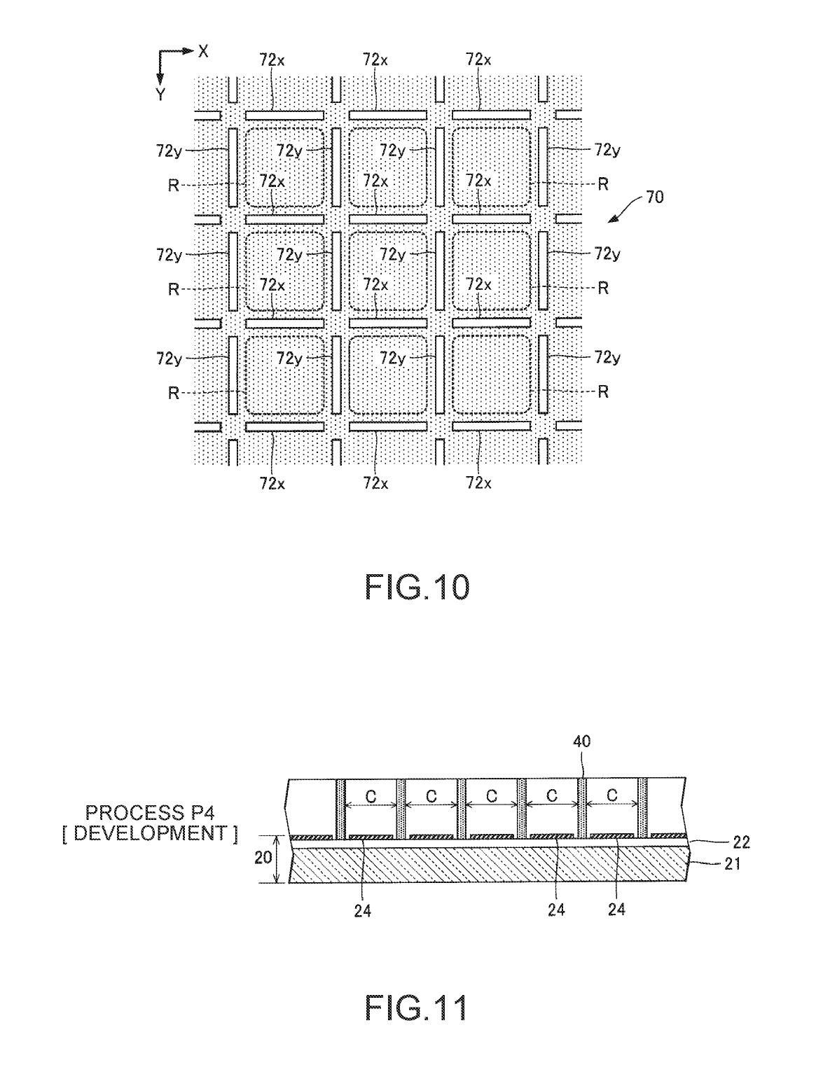

FIG. 10 is a plan view of the photomask 70 which is used in the process P3. As illustrated in FIG. 10, the transmissive area 72 of the photomask 70 in the first embodiment includes a plurality of areas 72x (an example of a first area) and a plurality of areas 72y (an example of a second area). The plurality of areas 72x and the plurality of portions 42x of the partition wall portion 40 correspond to each other one to one, and the plurality of areas 72y and the plurality of portions 42y of the partition wall portion 40 correspond to each other one to one. In FIG. 10, an area R corresponding to each pixel P is conveniently illustrated. A plurality of areas R are arrayed into a matrix in the X-direction and the Y-direction. Each area 72x of the photomask 70 is a long-shaped area that extends in the X-direction between two areas R which are adjacent to each other in the Y-direction. On the other hand, each area 72y is a long-shaped area that extends in the Y-direction between two areas R which are adjacent to each other in the X-direction. The plurality of areas 72x are arrayed at intervals to each other in the X-direction, and the plurality of areas 72y are arrayed at intervals to each other in the Y-direction.

As illustrated in FIG. 10, the area 72x and the area 72y are separated from each other. Specifically, in the photomask 70, the point in which the array of the plurality of areas 72x along the X-direction and the array of the plurality of areas 72y along the Y-direction intersect with each other is the light-shielding area 74 which shields the irradiation light.

In a process P4 (an example of a development process) after the process P3, as illustrated in FIG. 11, the photosensitive layer 60 after the exposure is developed with a developing solution, thereby, the partition wall portion 40 is formed. Specifically, a portion (portion overlapping with the transmissive area 72) which is exposed in the process P3 among the photosensitive layer 60 remains, and the portion which is not exposed in the process P3 among the photosensitive layer 60 is removed, thereby, the partition wall portion 40 of the planar shape illustrated in FIG. 5 is formed.

After the partition wall portion 40 is formed by the process P4, a cleaning treatment and a drying treatment are sequentially executed. For the washing treatment, for example, isopropyl alcohol (IPA) substitution and pure water washing are used. For example, an air knife is used for the drying treatment. The second substrate 20 in which the partition wall portion 40 is formed through the above processes, and the first substrate 10 in which the common electrode 12 and the insulating layer 14 are formed on the surface of the base material 11 in a separate process are bonded to each other, thereby, the electrophoresis device 100 of the first embodiment illustrated in FIG. 2 is manufactured.

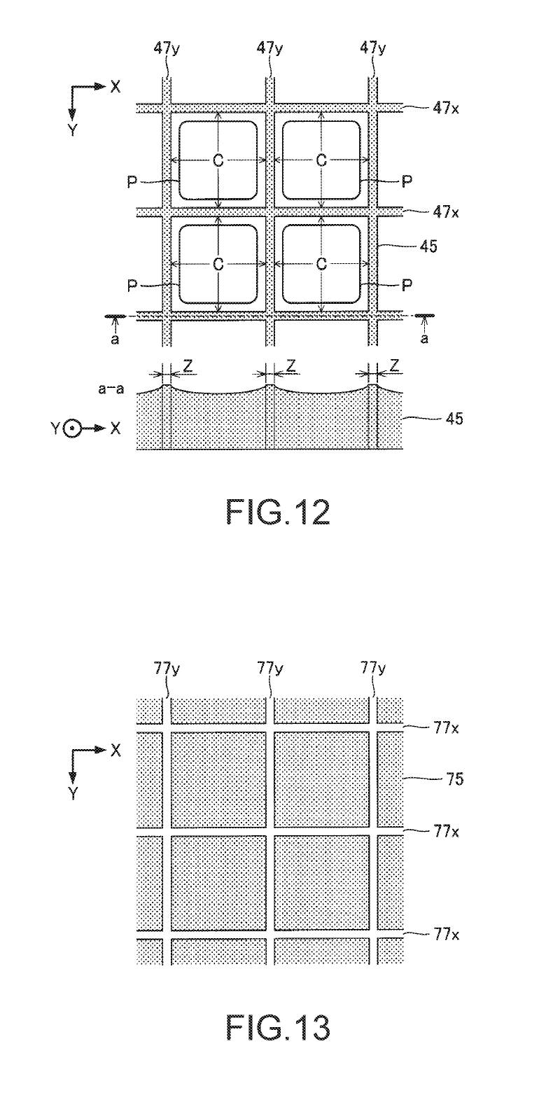

As Comparative Example with the first embodiment described above, as illustrated in FIG. 12, it is assumed that a lattice-shaped partition wall portion 45 is obtained by combining a plurality of portions 47x which extend into a straight line in the X-direction and a plurality of portions 47y which extend into a straight line in the Y-direction with each other. As illustrated in FIG. 13, a plurality of areas 77x which extends into a straight line in the X-direction and a plurality of areas 77y which extend into a straight line in the Y-direction are combined with each other, thereby, the lattice-shaped transmissive area is formed in a photomask 75 which used for the formation (exposure of the photosensitive layer 60) of the partition wall portion 45.

In a case where the photomask 75 of Comparative Example is used, an exposure value to a portion Z corresponding to the intersecting of the area 77x with the area 77y in the photosensitive layer 60 is larger than the exposure values to other portions. Therefore, as illustrated in the sectional view of FIG. 12, there is a possibility that a height of the portion Z of the partition wall portion 45 becomes high in comparison with other portions. If there is a difference (variation) in the height of the partition wall portion 45 as described above, there is a possibility that it is not possible to cause the partition wall portion 45 and the first substrate 10 (specifically, the surface of the insulating layer 14) to adhere to each other with high accuracy.

In contrast to Comparative Example, in the first embodiment, the photomask 70 in which each area 72x and each area 72y are separated from each other is used for the exposure of the photosensitive layer 60. Therefore, the exposure value to the portion Z corresponding to the intersecting of the array of the plurality of areas 72x with the array of the plurality of areas 72y in the photosensitive layer 60, is reduced in comparison with Comparison Example. Accordingly, it is possible to prevent the difference (variation) of the height of the partition wall portion 40, and it is possible to cause the partition wall portion 40 and the first substrate 10 to adhere to each other with high accuracy.

In a case where the partition wall portion 45 of FIG. 13 is formed, since the cell C is surrounded by the partition wall portion 45 throughout the entire circumference, various kinds of treatment liquids such as the developing solution may remain on the inside of the cell C. In the first embodiment, since the communicating portion Q that causes the cells C to communicate with each other is formed in the partition wall portion 40, the treatment liquid which is used in the manufacturing process flows out from the cell C by passing through the communicating portion Q. Therefore, according to the first embodiment, there is an advantage that it is possible to reduce the possibility such that the treatment liquid remains on the inside of the cell C.

### Second Embodiment

A second embodiment of the invention will be described. Regarding the component of which an effect or a function is the same as that of the first embodiment in each configuration described hereinafter, each detailed description will be appropriately omitted by diverting a mark which is used in the description of the first embodiment.

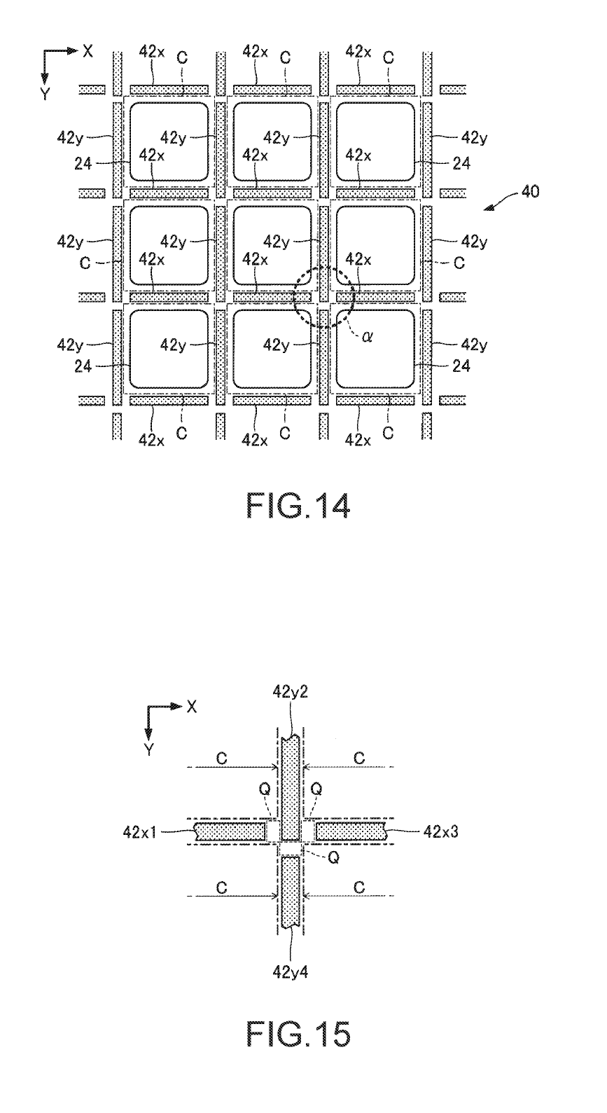

FIG. 14 is a plan view of the partition wall portion 40 of the electrophoresis device 100 according to the second embodiment, and FIG. 15 is a plan view obtained by enlarging the area α in FIG. 14. As illustrated in FIG. 14 and FIG. 15, in the partition wall portion 40 of the second embodiment, two portions 42x (42x1, 42x3) which are adjacent to each other in the X-direction are positioned on opposite sides to each other by interposing the portion 42y therebetween. Specifically, as illustrated in FIG. 15, the portion 42x1 (an example of the first portion) and the portion 42x3 (an example of the third portion) which are adjacent to each other in the X-direction, are formed at a position which is separated from the portion 42y2 through the communicating portion Q such that an end portion of the portion 42y2 on a positive side in the Y-direction is interposed therebetween. On the other hand, the portion 42y4 is formed at the position which is separated from the portion 42y2 in the Y-direction through the communicating portion Q, and is not positioned between the portion 42x1 and the portion 42x3.

The configuration in which the size of each communicating portion Q is set such that the charged particles 32 are not capable of passing through the communicating portion Q, is the same as that of the first embodiment. The photomask 70 in which the transmissive area 72 of the planar shape corresponding to the shape of the partition wall portion 40 is formed, is used for the exposure (process P3) of the photosensitive layer 60 which becomes the partition wall portion 40.

In the second embodiment, in the same manner as the first embodiment, it is possible to cause the dispersion medium 34 to flow between the cells C through the communicating portion Q of the partition wall portion 40. Since the communicating portion Q is formed in the portion where the array of the plurality of portions 42x and the array of the plurality of portions 42y intersect with each other, it is possible to prevent the difference of the height of the partition wall portion 40 due to the difference between the exposure values, in the same manner as the first embodiment.

### Third Embodiment

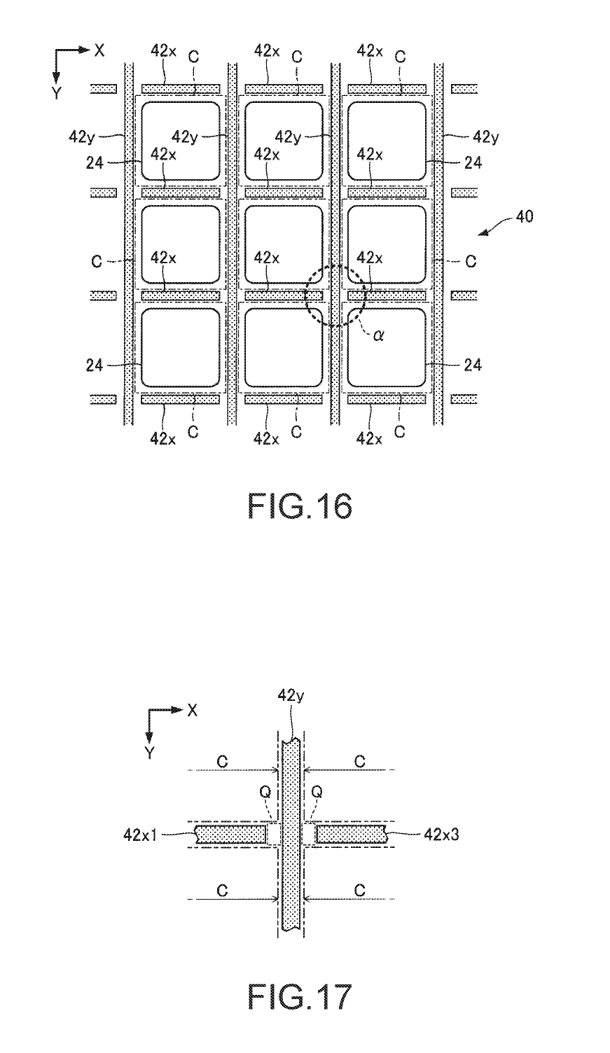

FIG. 16 is a plan view of the partition wall portion 40 of the electrophoresis device 100 according to a third embodiment, and FIG. 17 is a plan view obtained by enlarging the area α in FIG. 16. As illustrated in FIG. 16 and FIG. 17, the partition wall portion 40 of the third embodiment includes the plurality of portions 42y (an example of the second portion) which are arrayed side by side at intervals to each other in the X-direction. Each portion 42y is a long-shaped portion which is continuous in the Y-direction throughout the plurality of pixels P (pixel electrode 24).

In the partition wall portion 40 of the third embodiment, two portions 42x (42x1, 42x3) which are adjacent to each other in the X-direction are positioned on the opposite sides to each other by interposing the portion 42y therebetween. Specifically, the portion 42x1 (an example of the first portion) and the portion 42x3 (an example of a third portion) which are adjacent to each other in the X-direction, are formed at a position which is separated from the portion 42y through the communicating portion Q such that the portion 42y is interposed therebetween. The configuration in which the size of the communicating portions Q is set such that the charged particles 32 are not capable of passing through the communicating portion Q, is the same as that of the first embodiment. The photomask 70 in which the transmissive area 72 of the planar shape corresponding to the shape of the partition wall portion 40 is formed, is used for the exposure (process P3) of the photosensitive layer 60 which becomes the partition wall portion 40.

In the third embodiment, in the same manner as the first embodiment, it is possible to cause the dispersion medium 34 to flow between the cells C through the communicating portion Q of the partition wall portion 40. Since the communicating portion Q is formed in the portion where the array of the plurality of portions 42x and the array of the plurality of portions 42y intersect with each other, it is possible to prevent the difference of the height of the partition wall portion 40 due to the difference between the exposure values, in the same manner as the first embodiment.

### MODIFICATION EXAMPLE

Each embodiment described above may be variously modified. A specific aspect of the modification will be described hereinafter. The aspect described hereinafter may be applied to each embodiment described above. Two or more aspects which are arbitrarily selected from the following description, may be appropriately combined within the scope without contradicting each other.

(1) As described in each embodiment described above, the photomask 70 in which the area 72x and the area 72y of the transmissive area 72 are separated from each other is used for the exposing of the photosensitive layer 60, thereby, it is possible to prevent the difference of the height of the partition wall portion 40 due to the uneven distribution of the exposure value. From the viewpoint of realizing an effect described above, the configuration in which the communicating portion Q that causes the adjacent cells C to communicate with each other is formed in the partition wall portion 40, is not necessarily indispensable. That is, even in a case where the portion between the portion 42x and the portion 42y of the photosensitive layer 60 is not entirely removed in the process P4, if the photomask 70 which is described in each embodiment described above is used, the effect of preventing the difference of the height of the partition wall portion 40 is realized.

(2) In each embodiment described above, a case where the photosensitive layer 60 is formed of the negative type photosensitive material is described, but the photosensitive layer 60 may be formed of a positive type photosensitive material in which the exposed portion is removed after the development. In a case where the photosensitive layer 60 is formed of the positive type photosensitive material, a photomask in which the transmissive area 72 and the light-shielding area 74 have a reverse relationship to that of each embodiment described above, is used in the process P3.

(3) In each embodiment described above, the configuration in which the partition wall portion 40 is formed on the second substrate 20 is described, but the partition wall portion 40 may be formed on the first substrate 10. The first substrate 10 and the second substrate 20 are bonded to each other, thereby, the partition wall portion 40 on the surface of the first substrate 10 is in contact with the surface (surface of the circuit layer 22, in more detail) of the second substrate 20.

(4) In each embodiment described above, the cell C is formed per pixel P, but a correspondence relationship between the pixel P and the cell C is not limited thereto. For example, it is possible to form the cell C by the plurality of pixels P which are adjacent to each other, as a unit.

### Electronic Apparatus

The electrophoresis device 100 described above may be used for various electronic apparatuses. A specific form of the electronic apparatus using the electrophoresis device 100 will be described hereinafter.

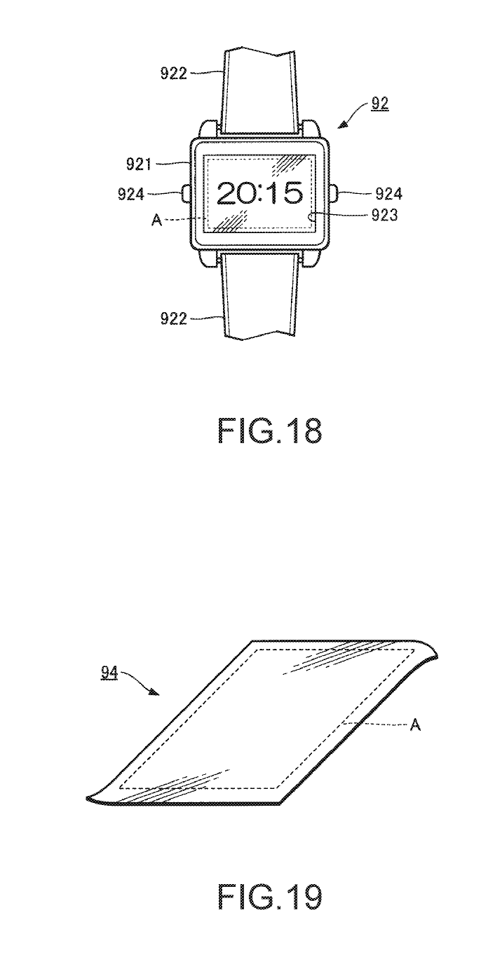

FIG. 18 is a front view of a wristwatch 92 using the electrophoresis device 100 as a display device. As illustrated in FIG. 18, the wristwatch 92 is a wearable apparatus including a housing 921 that accommodates the electrophoresis device 100, and a band 922 that is connected to the housing 921. The user may wear the wristwatch 92 by winding the band 922 around a wrist. The pixel area A of the electrophoresis device 100 is exposed from an opening 923 of the housing 921, and is used in the display of various kinds of information such as time. If an operator 924 that is installed in the housing 921 is operated, for example, the image which is displayed in the pixel area A is changed.

FIG. 19 is a perspective view of an electronic paper 94 using the electrophoresis device 100. As illustrated in FIG. 19, the electronic paper 94 includes the electrophoresis device 100 using a sheet that may be elastically deformed as a base material 11 and a base material 21, and displays various kinds of images within the pixel area A.

The electronic apparatus to which the invention is applied is not limited to the examples described above. For example, it is possible to use the electrophoresis device according to each aspect of the invention for various kinds of electronic apparatuses such as an information terminal such as a mobile phone or an electronic book, a portable sound reproducing device, or a touch panel mounted display device.

The entire disclosure of Japanese Patent Application No. 2017-012000, filed Jan. 26, 2017 is expressly incorporated by reference herein.

What is claimed is:

1. An electrophoresis device comprising:
a first substrate and a second substrate that retain an electrophoretic dispersion liquid including charged particles and a dispersion medium; and
a partition wall portion that partitions a gap between the first substrate and the second substrate into a plurality of cells,
wherein the partition wall portion includes a communicating portion that causes the adjacent cells to communicate with each other.

2. The electrophoresis device according to claim 1,
wherein the communicating portion has a size through which the charged particles are not capable of passing.

3. The electrophoresis device according to claim 1,
wherein the partition wall portion includes
a first portion that extends in a first direction, and
a second portion that extends in a second direction intersecting with the first direction, and
the first portion and the second portion are disposed to be separated from each other through the communicating portion.

4. The electrophoresis device according to claim 3,
wherein the partition wall portion includes a third portion that extends in the first direction, and
the first portion and the second portion are disposed to be separated from the third portion through the communicating portion.

5. The electrophoresis device according to claim 3,
wherein the partition wall portion includes a fourth portion that extends in the second direction, and
the first portion, the second portion, and the third portion are disposed to be separated from the fourth portion through the communicating portion.

6. The electrophoresis device according to claim 1,
wherein the partition wall portion includes
a first portion that extends in a first direction,
a second portion that extends in a second direction intersecting with the first direction, and
a third portion that extends in the first direction,
the first portion and the third portion are positioned on opposite sides to each other by interposing the second portion between the first portion and the third portion, and
each of the first portion and the third portion are disposed to be separated from the second portion through the communicating portion.

7. An electronic apparatus comprising:
the electrophoresis device according to claim 1.

8. An electronic apparatus comprising:
the electrophoresis device according to claim 2.

9. An electronic apparatus comprising:
the electrophoresis device according to claim 3.

10. An electronic apparatus comprising:
the electrophoresis device according to claim 4.

11. An electronic apparatus comprising:
the electrophoresis device according to claim 5.

12. An electronic apparatus comprising:
the electrophoresis device according to claim 6.
